(19) United States
(12) Patent Application Publication
(10) Pub. No.: US 2024/0157942 A1
(43) Pub. Date: May 16, 2024

(54) METHOD AND DEVICE FOR DEACTIVATING AN ASSISTED OR AUTOMATED DRIVING FUNCTION

(71) Applicant: Robert Bosch GmbH, Stuttgart (DE)

(72) Inventors: Lukas Schweizer, Metzingen (DE); Robin Welz, Mauer (DE)

(21) Appl. No.: 18/503,397

(22) Filed: Nov. 7, 2023

(30) Foreign Application Priority Data
Nov. 10, 2022 (DE) 10 2022 211 908.8

(51) Int. Cl. B60W 30/18

(52) U.S. Cl. CPC B60W 30/18109; B60W 2300/36; B60W 2540/12

(57) ABSTRACT

A method for deactivating an assisted or automated driving function in a motor vehicle, with which the driving function carries out a driver-independent braking intervention and with which the driving function is thereby deactivated. The driver actuates a braking request presetting device, wherein the duration of actuation by the driver is between a lower limit value and an upper limit value, or the driver actuates the braking request presetting device in such a way that the intensity of the braking requested by the driver is greater than the intensity of the braking exerted by the driving function.

### CROSS REFERENCE

The present application claims the benefit under 35 U.S.C. § 119 of German Patent Application No. DE 10 2022 211 908.8 filed on Nov. 10, 2022, which is expressly incorporated herein by reference in its entirety.

### BACKGROUND INFORMATION

German Patent Application No. DE 10 2012 215 057 A1 describes a driver assistance system for motor vehicles, having a longitudinal guidance controller and a transverse guidance controller, having at least one control element by means of which the transverse guidance controller can be activated only together with or in addition to the longitudinal guidance controller, having a steering sensor that detects actuation of the steering wheel of the vehicle by the driver, wherein the lateral guidance controller can be deactivated by a signal from the steering sensor without the longitudinal guidance controller being deactivated, and having a brake pedal sensor that detects actuation of the brake pedal of the vehicle, wherein the lateral guidance controller and the longitudinal guidance controller can be deactivated by a signal from the brake pedal sensor.

### SUMMARY

The present invention relates to a method for deactivating an assisted or automated driving function in a motor vehicle, with which the driving function carries out a driver-independent braking intervention and with which the driving function is thereby deactivated. According to an example embodiment of the present invention:
the driver actuates a braking request presetting device, wherein the duration of actuation by the driver is between a lower limit value and an upper limit value, or
the driver actuates the braking request presetting device in such a way that the intensity of the braking requested by the driver is greater than the intensity of the braking exerted by the driving function.

This provides the driver with two different deactivation options for the driving function, such that he can select the type of deactivation. This can also be formulated in such a way that the driving function includes two deactivation options, wherein the first deactivation option is that the driver actuates the braking request presetting device, wherein the duration of actuation by the driver is between a lower limit value and an upper limit value, and the second deactivation option is that the driver actuates the braking request presetting device in such a way that the intensity of braking requested by the driver is greater than the intensity of braking exerted by the driving function.

In an advantageous embodiment of the present invention, the assisted or automated driving function is a distance and/or speed control function.

In an advantageous embodiment of the present invention, the braking request presetting device is a brake pedal.

In an advantageous embodiment of the present invention, the intensity of the braking is the braking force.

In an advantageous embodiment of the present invention, the intensity of the braking is the braking torque.

In an advantageous embodiment of the present invention, the intensity of the braking is the longitudinal deceleration.

In an advantageous embodiment of the present invention, the motor vehicle is a two-track motor vehicle.

The present invention also comprises a device containing means that are designed to carry out the method according to the present invention. In particular, this is a control device in which the program code for carrying out the method according to the present invention is stored.

### BRIEF DESCRIPTION OF THE DRAWING

FIG. 1 shows the basic sequence of an example embodiment of a method according to the present invention.

### DETAILED DESCRIPTION OF EXAMPLE EMBODIMENTS

The present invention is concerned with a deactivation strategy for assisted or automated driving functions, for example the ACC function, during a braking process. In particular, it is an optimized deactivation condition for assisted and automated driving functions during deceleration in which the driver brakes. Such deactivation conditions assist the driver
with critical situations, for example if a vehicle driving ahead is decelerating very strongly and the driver wishes to take over vehicle control by deactivating the driving function only if the driver wants a stronger vehicle deceleration than the current vehicle deceleration by the driving function and
with “normal” deactivation, by the driver actuating the brake pedal for a short time and releasing it again.

In the first case, the driver is assisted in critical situations by the assisted function maintaining deceleration until the deceleration achieved by the driver is stronger. This shortens the braking distance and supports maintenance of the maximum possible distance from the vehicle driving ahead. An exemplary situation is when the vehicle driving ahead is decelerating very strongly and the assisted function has reached its deceleration limit. For the assisted function, for example an ACC function, in certain circumstances it is not possible to prevent an accident. If the driver steps on the brake pedal, the maximum possible deceleration is maintained by the driving function until the driver decelerates even more strongly.

In the second case, the driver can deactivate the driving function at any time by tapping the brake pedal in order to stop the automatic acceleration or deceleration caused by the driving function.

The deactivation of the driving function due to an actuation of the driver brake pedal is performed with each of the following two logics:
1) The driver brake request, i.e. driver brake pressure is greater than the deceleration of the function or brake request of the driving function:

|Fx_Driver_Brake|>|Fx_Function_Brake|,
where |Fx_Driver_Brake| represents the braking force amount desired by the driver and |Fx_Function_Brake| represents the braking force amount provided by the driving function.
2) The driver taps the brake pedal. In this case, the length of time the brake pedal is actuated is measured. If this length of time is greater than a minimum time and less than a maximum time, deactivation is recognized.

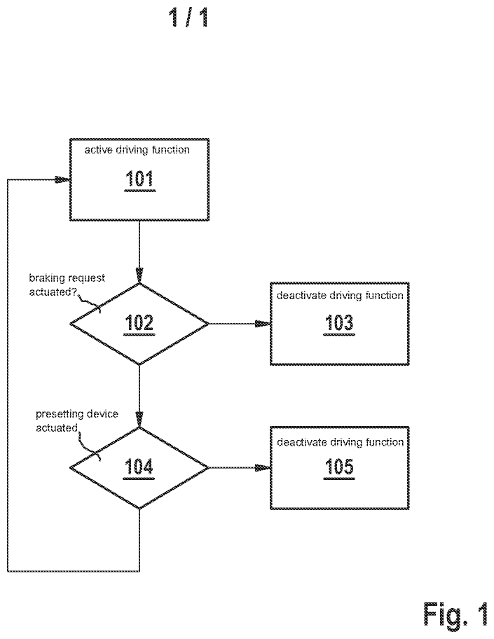

FIG. 1 shows the basic sequence of an embodiment of the method according to the present invention. After the start of the method with an active driving function in block 101, it is checked in block 102 whether the driver is actuating a braking request presetting device, wherein the duration of actuation by the driver is between a lower limit value and an upper limit value. If this is the case, then the driving function is then deactivated in block 103. However, if this is not the case, then in block 104 it is subsequently queried whether the driver is actuating the braking request presetting device such that the intensity of braking requested by the driver is greater than the intensity of braking exerted by the driving function. If this is the case, the driving function is then deactivated in block 105. If this is not the case either, then the sequence subsequently returns to block 101.

What is claimed is:

1. A method for deactivating an assisted or automated driving function in a motor vehicle, the method comprising the following steps:
carrying out, by the driving function, a driver-independent braking intervention; and
deactivating the driving function when:
the driver actuates a braking request presetting device, wherein a duration of actuation by the driver is between a lower limit value and an upper limit value; or
the driver actuates the braking request presetting device in such a way that an intensity of the braking requested by the driver is greater than an intensity of a braking exerted by the driving function.

2. The method as recited in claim 1, wherein the assisted or automated driving function is a distance and/or speed control function.

3. The method as recited in claim 1, wherein the braking request presetting device is a brake pedal.

4. The method as recited in claim 1, wherein the intensity of the braking is a braking force.

5. The method as recited in claim 1, wherein the intensity of the braking is the braking torque.

6. The method as recited in claim 1, wherein the intensity of the braking is the longitudinal deceleration.

7. The method as recited in claim 1, wherein the motor vehicle is a two-track motor vehicle.

8. A device including a control unit configured to deactivate an assisted or automated driving function in a motor vehicle, the driving function carrying out a driver-independent braking intervention, the control unit configured to:
deactivate the driving function when:
the driver actuates a braking request presetting device, wherein a duration of actuation by the driver is between a lower limit value and an upper limit value; or
the driver actuates the braking request presetting device in such a way that an intensity of the braking requested by the driver is greater than an intensity of a braking exerted by the driving function.
